(19) United States
(12) Patent Application Publication
(10) Pub. No.: US 2004/0146841 A1
(43) Pub. Date: Jul. 29, 2004

(54) S.E.N.I.T / S.E.A.A sleeping education for newborns, infants, & toddlers/ sleeping education for adolescence and adults

(76) Inventor: Ronald Christopher Minton, Danville, IN (US)

Correspondence Address: RONALD C. MINTON, 3400 PRARIEVIEW CIRCLE, DANVILLE, IN, 46122, US

(21) Appl. No.: 10/347,909

(22) Filed: Jan. 23, 2003

(51) Int. Cl. G09B 19/00

(52) U.S. Cl. 434/236

(57) ABSTRACT

The S.E.N.I.T/S.E.A.A is an educational program geared towards the age span of 3rd. Trimester through age 3. The Educational program is of an audio nature by which the learning material is formatted to deliver directly to the developing neural pathway of the child while they sleep. The program is played three (3) times a week at minimum of 21 minutes per session. This; over a period of at least 12 months, will give the child a means to recall the desired in formation much quicker than standard oratory teaching. Therby giving the child a jumpstart in education.

The S.E.N.I.T/S.E.A.A invention is an audio program of an Educational origin. The S.E.N.I.T/S.E.A.A Educational Au dio Program is designed to deliver educational and moral enhancement material directly into the neural pathway of the developing mind of a child in the age range of 3rd. Trimester through 3 years of age.

The S.E.N.IT/S.E.A.A Educational Audio Program was designed to teach basic and advanced alphanumeric skills into developing neural pathways of infants giving the child a jump start in learning. Thus allowing the child to have a quicker and easier recall of the desired information giving them (Infants) a more stronger level of self esteem and creating a “Wanting to Learn”.

The S.E.N.I.T/S.E.A.A Educational Audio Program is formatted compact discs and/or audio cassette.

1. What I claim as my Invention is the S.E.N.I.T/S.E.A.A Educational Audio Program utilizing the following frequencies: (3.5-7.5 Hz) and take audio recordings and reverse and compress the information in order to deliver the information directly into the neural pathway of Newborns, Infants, and Toddlers. (Age 3rd. Trimester through 3 yrs. Old.)
